(19) United States
(12) Patent Application Publication
(10) Pub. No.: US 2011/0084047 A1
(43) Pub. Date: Apr. 14, 2011

(54) Methods For Fabrication Of Large Core Hollow Waveguides

(76) Inventors: Jong-Souk Yeo, Corvallis, OR (US); Neal Meyer, Corvallis, OR (US); Charlotte Rae Lanig, Albany, OR (US); Robert Newton Bicknell, Corallis, OR (US); Paul Kessler Rosenberg, Sunnyvale, CA (US)

(21) Appl. No.: 12/991,648

(22) PCT Filed: May 9, 2008
(86) PCT No.: PCT/US08/63283

§ 371 Date: Jan. 3, 2011

(51) Int. Cl. B29D 11/00; B32B 38/06; B32B 38/10

(52) U.S. Cl. 216/24; 264/1.24; 156/221; 156/196; 156/60; 156/272.8

(57) ABSTRACT

Methods for making a photonic guiding system for directing coherent light are disclosed. The methods include forming a channel in a host layer using at least one process of sawing, laser ablation, laser direct write of a photoresist, photo-structuring, and etching. A layer of highly reflective material is applied to substantially cover an interior of the channel. A cover having a layer of highly reflective material is coupled over the channel to form a large core hollow waveguide.

### BACKGROUND

As computer chip speeds on circuit boards increase to ever faster speeds, a communications bottleneck in inter-chip communication is becoming a larger problem. One likely solution is to use fiber optics to interconnect high speed computer chips. However, most circuit boards involve many layers and often require tolerances in their manufacture of less than a micron. Physically placing fiber optics and connecting the fibers to the chips can be too inaccurate and time consuming to be widely adopted in circuit board manufacturing processes.

Routing the optical signals around and between circuit boards can add significant additional complexity. Marketable optical interconnects between chips have therefore proven illusive, despite the need for broadband data transfer.

### BRIEF DESCRIPTION OF THE DRAWINGS

FIG. 1a is an illustration of an embodiment of a host layer carried by a substrate;

FIG. 1b illustrates an embodiment of a channel formed in the host layer of FIG. 1a;

FIG. 1c illustrates an embodiment of a reflective coating applied over the channel of FIG. 1b to form a base portion;

FIG. 1d illustrates an embodiment of a lid portion having a reflective coating;

FIG. 1e illustrates the lid portion coupled to the base portion of FIG. 1c in accordance with an embodiment;

FIG. 1f illustrates an embodiment of a channel formed in multiple laminate layers;

FIG. 1g illustrates an embodiment of a multiple channels formed in multiple laminate layers;

FIG. 2 is a flow chart depicting an embodiment of a method 500 for making a photonic guiding device for directing coherent light;

FIG. 3 is a flow chart depicting an embodiment of a method 600 for making a photonic guiding device for directing coherent light;

FIG. 4a illustrates an embodiment of a channel formed in the host layer using an etching process in the 100 crystallographic orientation;

FIG. 4b illustrates an embodiment of a first and second channel from FIG. 4a coupled to form a substantially square large core hollow metal waveguide;

FIG. 4c illustrates an embodiment of a channel formed in the host layer using an etching process in the 110 crystallographic orientation;

FIG. 4d illustrates a lid portion coupled to the base portion of FIG. 4c in accordance with an embodiment;

FIG. 5 is a flow chart depicting an embodiment of a method 700 for making a photonic guiding device for directing coherent light.

FIG. 6a illustrates an embodiment of a large core hollow waveguide used to interconnect two circuit boards;

FIG. 6b illustrates an embodiment of a large core hollow waveguide used to interconnect electronic components on a circuit board;

FIG. 6c illustrates an embodiment of a large core hollow waveguide with a slot cut at a predetermined angle to enable a redirecting device to be inserted into the slot;

FIG. 7a illustrates an embodiment of a two dimensional array of large core hollow waveguides having a reflective coating;

FIG. 7b illustrates an embodiment of a three dimensional array of large core hollow waveguides having a reflective coating; and

FIG. 7c illustrates an embodiment of an array of hollow metal waveguides coupled to a circuit board and a plurality of daughter cards.

### DETAILED DESCRIPTION OF EXAMPLE EMBODIMENTS

One method for forming optical interconnects between computer chips on a circuit board is to use optical waveguides formed on the circuit board. Optical waveguides can be superior to fiber optic communications because of the ability to form the waveguides on the circuit board using lithographic or similar processes. The waveguides are typically formed on the circuit boards with substantially optically transparent material, such as polymers and/or dielectrics. Optical waveguides made using lithographic or similar processes can also be formed on other types of substrates that are not mounted on a circuit board. For example, optical waveguide(s) may be formed on a flexible substrate to create a ribbon cable having one or more optical waveguides.

Forming optical waveguides in this fashion can provide interconnects that are constructed with the necessary physical tolerances to be used on modern multi-layer circuit boards. However, the polymers, dielectrics, and other materials that can be used in chip and circuit board manufacture to form the on-board waveguides are typically significantly more lossy than fiber optics. Indeed, the amount of loss in on-board waveguides has been one of the factors limiting the acceptance of optical waveguide interconnects. Polymers used to construct the waveguides can have a loss of 0.1 dB per centimeter. In contrast, the loss in a fiber optic is around 0.1 dB per kilometer. Thus, polymer waveguides can have losses that are orders of magnitude greater than the loss in fiber optics.

In addition, typical waveguides are usually manufactured to have dimensions that are roughly proportional with the wavelength of light they are designed to carry. For example, a single mode waveguide configured to carry 1000 nm light may have a dimension of 1000 nm to 5000 nm (1 μm to 5 μm) for the higher index core region and surrounded by a lower index cladding region. Multimode waveguides may have larger dimensions on the order of 20-60 um for the core region. Both single and multimode waveguides have a relatively high numerical aperture (NA) of around 0.2 to 0.3 for a core and clad refractive index contrast of 0.01 to 0.02. The numerical aperture determines the divergence of beam from the emitting fiber. A larger NA will result in poor coupling as a function of fiber to fiber separation. Thus, connecting waveguides of this size can be expensive and challenging.

Splitting and tapping of the guided optical beams are also difficult to accomplish using these waveguides. The cost of creating and connecting waveguides has historically reduced their use in most common applications. In accordance with one aspect of the invention, it has been recognized that an inexpensive photonic guiding device is needed that is simpler to interconnect with other waveguides and optical devices and that can significantly reduce the amount of loss in an optical waveguide.

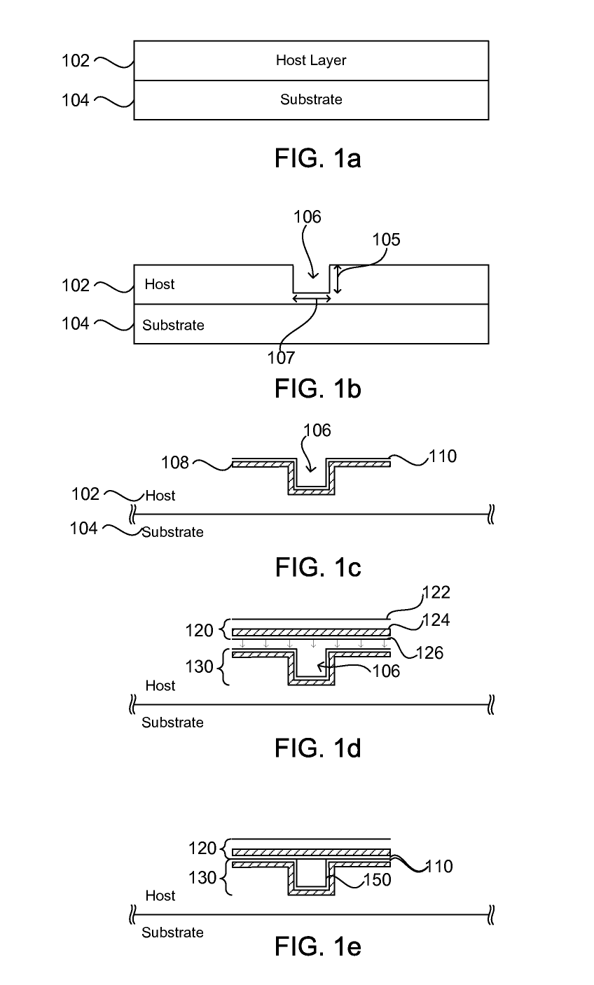

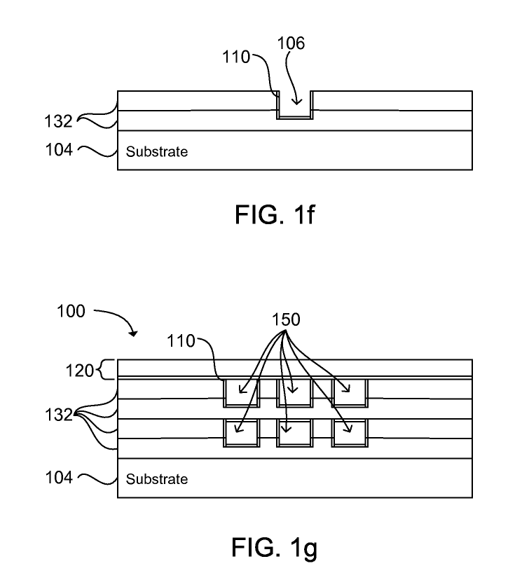

In accordance with an embodiment of the present invention, FIGS. 1a through 1e provide an illustration of a method of making a photonic guiding device. This optical waveguide is comprised of a hollow core with a high reflective cladding layer. It operates on the principle of attenuated total internal reflection different from conventional optical waveguides which rely on total internal reflection at the critical angle formed between the core and clad of the waveguide. FIG. 1a shows a host layer 102 being carried by a substrate 104. The substrate may be comprised of a variety of different types of materials. For example, the substrate may be a flexible material such as plastic or a printed circuit board material. The circuit board material can be configured to be rigid or flexible. Alternatively, the substrate may be formed of a semiconductor material.

The host layer 102 can be formed on top of the substrate material. The host layer may also be a type of flexible material such as a polymer or a semiconductor material to enable the material to be processed using standard lithographic processes. A channel 106 can be formed in the host layer, as shown in FIG. 1b.

The use of the term large core is intended to mean that the height 105 and/or width 107 of the channel 106 can be substantially greater than a wavelength of the coherent light that is directed in the photonic guiding device. For example, the height or width may be 50 to over 100 times greater than the wavelength of the coherent light. The height and width of the channel is typically selected to be relatively similar. If one dimension is substantially different that the other then losses can occur in an optical beam carried in the channel due to decoupling of polarization of the optical beam that occurs when the two dimensions are substantially different. Thus, the ratio of the dimensions is typically less than ten.

The channel 106 may be formed using a number of processes. Several different processes have been developed to form the channel in a manner that will enable a high speed modulated optical signal (greater than 1 gigabits per second) to travel through the channel with the output optical signal(s) having desired characteristics. The processes that have been developed include sawing of the substrate to form the channel, laser micromachining, laser direct writing, photo-structuring, and etching along a desired crystallographic axis. These processes will be further described below.

In one embodiment, a saw can be used to form a channel having a desired height 105 and width 107 for a determined length along the host layer 102. For example, a dicing saw can be used to form the at least one channel. A dicing saw is a kind of saw which employs a high-speed spindle fitted with an extremely thin diamond blade or diamond wire to dice, cut, or groove semiconductor wafers, silicon, glass, ceramic, crystal, polymer or plastic, and many other types of material. In one embodiment, a saw with a single blade can be used to form a single channel at one time. The channel may have a width substantially similar to a width of the blade. The width of channel cut by a saw blade is called a kerf width. Alternatively, multiple passes may be made with the blade to form a channel having a width wider than the blade. In another embodiment, the dicing saw can include gang blades comprising two or more blades that can be used to cut multiple waveguide channels in one pass. In another embodiment, the dicing saw can include multiple spindle comprising two or more spindles with similar or different blades at varying gap between the spindles to form a single or multiple waveguide channels in one pass.

To facilitate a reduction in scattering of the coherent light within the photonic guiding device, the walls of the channel 106 can be smoothed to reduce or eliminate roughness. Ideally, any extruding features along the walls should be substantially less than a wavelength of the coherent light. Depending on the desired optical qualities of the waveguide, the channel(s) can be further polished using an etching process to obtain smooth side walls.

In one embodiment, a Disco brand DFD651 dicing saw can be used with a Disco brand NBC-ZB 2050 blade to form one or more channels 106 in a silicon host layer. The NBC series blade is a combination of an ultra-thin diamond blade and an aluminum hub providing enhanced operational efficiency and stable cutting results. The blade is typically made of abrasive diamonds embedded in an electroplated metal matrix binder. The blade has a thickness of approximately 150 micrometers. Thus, a channel that is approximately 150 micrometers wide (the kerf width) can be formed in a single pass using the blade, assuming minimal chipping or wear on the sides of the channel caused by the blade.

In order to minimize defects within the channel while maintaining reasonable throughput, it has been found that a blade with a #2000 grit can be used to form a channel that provides desired optical qualities. Higher number grits are finer, thereby providing a smoother and cleaner cut, but tend to cause blades to stick during the cutting process. The saw blade can be moved through the host layer 102 at a typical rate (the feed-rate) of approximately six millimeters per second with a spindle speed of approximately 30,000 revolutions per minute. The feed rate can vary between 5 and 20 millimeters per second, with a variation in the spindle speed of between 25,000 and 45,000 revolutions per minute. When a blade with a finer grit (higher number) is used, the spindle speed can be increased and the feed rate decreased to provide a smoother surface. However, the higher spindle speed or feed rate can cause breakage of the blade and the lower feed rate can reduce throughput.

The Disco brand NBC-ZB 2050 blade can be used to form a channel 106 with a single pass in the host layer 102, with the channel having a width and a depth of approximately 150 micrometers. The use of a substantially square channel can be beneficial in an optical waveguide. If one dimension is substantially greater than the other, it can cause decoupling of the polarization of the light, thereby leading to polarization sensitive waveguide and additional loss in an optical beam that is propagated through the waveguide.

Other types of blades can be used for different types of host layer 102 materials. For example, a soft bonded metal blade can be used for polymeric material such as the SU8 photoresist, U5000 reflective graphic film, or kapton. SU8 is a family of chemically amplified, epoxy based negative resists manufactured by MicroChem Corporation. A resinoid or solid resin blade can be used for glass, or a metal blade for silicon.

After a channel 106 was formed using the Disco brand NBC-ZB 2050 blade, a polishing etch was found to smooth the edges of the channel and heal the micro-cracks caused by the saw blade. However, optical performance was determined to be within desired parameters without the use of the polishing etch for sawn waveguides. Therefore, a polishing etch may not be necessary after cutting the channel using a dicing saw, depending on such variables as the host layer material type, the type of saw blade, the speed of the saw blade, the feed rate of the host layer past the saw blade, and so forth.

If polish etching is needed, various solutions of hydrofluoric acid, nitric acid, and acetic acids can be used at room temperature to etch the host material to provide a smoother finish. Additionally, a solution of tetramethylammonium hydroxide (TMAH) can be used as an anisotropic etchant of silicon that is typically used at slightly elevated temperature to etch the host layer 102 after a channel has been formed using a dicing saw or similar process. Experimental use of the etchants showed improvements in the smoothness of the edges of the channel and average surface roughness. However, as noted above, the improved surface properties did not result in a decrease of loss in the optical signal for silicon based waveguide channels. However, a polish etching using the above listed etchants, or similar etchants, may be used when surface roughness or channel edges are not within a desired level of smoothness relative to a wavelength of the optical signal for various host materials.

In addition to silicon, the host layer 102 in which the channels are cut may also be formed of other types of materials. For example, in an embodiment illustrated in FIG. 1c, the host layer can be a printed circuit board material, such as Flame-Retardant 4 (FR4) board. In one embodiment, channels 106 can be cut into the FR4 board. A thin layer of a solvent dispensable polymeric layer 108, such as SU8 photoresist, can then be applied to the host layer 102 and channel 106 using coating techniques such as doctor blading, spin coating, ink-jetting, screen printing, and so forth. The polymeric layer can then be polymerized with ultraviolet light or heating. A metallization layer 110 of a highly reflective material such as silver can then be applied to the board to form a channel for a large core hollow metal waveguide.

Alternatively, a relatively thick layer of polymeric material such as SU8 may be formed on a substrate such as the FR4 board. In this embodiment, the SU8 can act as the host layer 102 and the FR4 board can act as the substrate layer 104. For example, a layer of SU8 having a thickness of approximately 200 micrometers or more can be deposited or laminated on the FR4 board. At least one channel 106 can be formed using a saw such as a dicing saw, as previously discussed. Each channel can be approximately 150 micrometers wide and 150 micrometers deep in the exemplary embodiment, though the actual dimensions are dependent on the wavelength of light used in an optical signal sent through the waveguides. A metallization layer 110 can be added after the channels are cut.

In another embodiment, multiple channels 106 can be formed in a polymer host material 106 such as SU8 using an embossing or molding process such as injection molding or compression molding to form the hollow core waveguide structures. These structures can then be bonded or laminated together to form three dimensional structures having a plurality of hollow metal waveguides. Three dimensional structures will be discussed more fully below.

The metallization layer 110 can be comprised of a plurality of layers. For example, in one embodiment, the metallization layer can include a titanium buffer that is used as an adhesion improving layer on a host material, an a silver reflective metal layer, and an aluminum nitride passivation layer used to protect the reflective layer. The metallization layer can be applied to the channel 106 using various deposition processes including physical vapor deposition processes such as sputtering, evaporation, ion plating, and chemical vapor deposition processes such as LPCVD (low pressure), PECVD (plasma enhanced), ALD (atomic layer deposition), and liquid phase deposition processes such as plating, electro-deposition etc. with various metallic layers.

FIG. 1d illustrates a lid portion 120 that can be formed of a cover material 122 that is layered with a metallization layer 126. The metallization layer can include an adhesion layer and a passivation layer. The metallization layer and cover material can be formed of the same materials as are used in forming the channel 106.

After the lid portion 120 has been formed, the lid portion can be laminated or bonded to the base portion 130, as illustrated in FIG. 1e. In one embodiment, the lid portion and the base portion can be bonded using wafer scale bonding. Wafer level bonding can be accomplished using plasma bonding between Pyrex glass and silicon, silicon/tantalum/gold to silicon, or silicon/thermal oxide or silicon/TEOS (Tetra Ethyl Ortho Silicate) to silicon. Silicate bonding can be used for oxide surfaces and glasses. Adhesive bonding processes can be used for various other types of materials such as polymers and composites.

When the lid portion 120 is bonded to the base portion 130, a large core hollow waveguide 150 is formed. The large core hollow waveguide has a reflective coating 110 covering an interior of the hollow waveguide. The reflective coating enables light to be reflected from a surface of the metal coating to reduce attenuation of laser light as it is directed through the waveguide.

In another embodiment, the host layer 102, as shown in FIGS. 1a-1e, can be formed by bonding or laminating a plurality of layers of material together, such as a plastic, composite, FR4 board, and the like. FIG. 1f shows a substrate 104 comprising a plurality of layers 132 laminated together. A channel 106 can be formed in the laminate layers using a dicing saw, as previously discussed. A metallization layer 110 can then be added within the channel. A plurality of large core hollow metal waveguides 150 can be formed and stacked together to form three dimensional array 160 of hollow metal waveguides within multiple layers of a printed circuit board, as illustrated in FIG. 1g. The multiple layers can be bonded or laminated together. A lid portion 120 having a metallization layer 110 may be laminated above the channels to form the hollow metal waveguides. Alternatively, an additional laminate layer, such as FR4 may be metallized and applied to form a top of the hollow metal waveguides.

Printed circuit boards are typically composed of multiple conductive layers separated and supported by layers of insulating material that are laminated together. Insulating layers with predefined waveguide channels can be laminated with a lid insulating layer 120 that is metallized to form hollow metal waveguides within the printed circuit board.

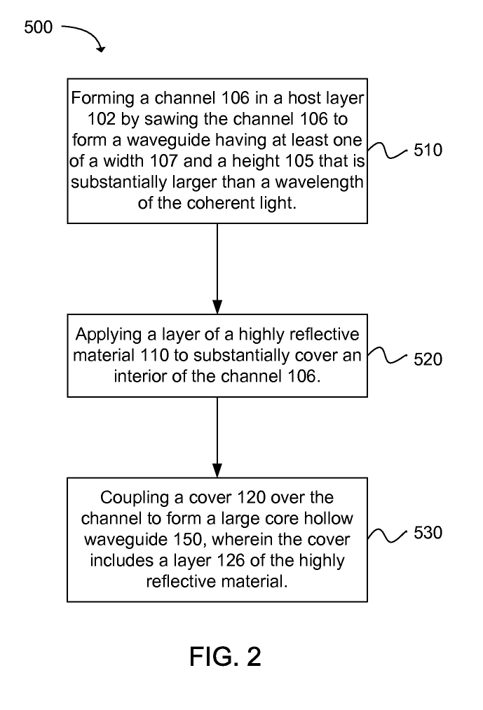

In another embodiment, a method 500 for making a photonic guiding system for directing coherent light is disclosed, as depicted in the flow chart of FIG. 2. The method includes the operation of forming 510 a channel 106 in a host layer 102 by sawing the channel 106 to form a waveguide configured to interconnect electronic circuitry on at least one circuit board. The channel 106 has at least one of a width 107 and a height 105 that is substantially larger than a wavelength of the coherent light. The method further includes the operation of applying 520 a layer of a highly reflective material 110 to substantially cover an interior of the channel 106. An additional operation includes coupling 530 a cover 120 over the channel to form a large core hollow waveguide 105. The cover 120 includes a layer 126 of the highly reflective material.

In another embodiment, laser ablation based micromachining can be used to form one or more channels in a host layer 102, as illustrated in FIG. 1b. A solid state laser or excimer laser can be used that has a fluence on the order of tens of joules per centimeter squared to around 100 joules per centimeter squared. The wavelength of the laser used for ablation based micromachining is typically a wavelength that is readily absorbed by the host layer material. A typical wavelength for ablation for a host layer made substantially of silicon is around 355 nanometers for a pulsed laser having 30 nanosecond pulse widths, but the conditions of ablative lasers are not limited to this particular example as there are various mechanisms involved in the removal of materials. Fluence thresholds for polymers are an order of magnitude smaller, so a channel can be formed in polymer materials using a laser with a significantly lower power output. Various other laser parameters will now be discussed in more detail.

A laser having a shorter pulse width is typically useful for laser ablation based micromachining. A shorter pulse width usually provides a channel with sharper edges and cleaner surfaces. When the pulse width becomes substantially shorter than the electron-phonon interaction time, on the order of picosecond range, the ablation process becomes an athermal process. While the individual pulse-material interaction is non-thermal in nature with a femtosecond pulsed laser, cumulative pulses can still result in accumulated heat forming a heat affected zone near a surface of the laser machined features.

Selecting a proper spot size for laser ablation based micromachining can enable a channel 106 of a desired width to be formed. A solid state laser with a galvanometric telecentric lens can be used to produce a spot size in the range of 10 to 100 micrometers. The size of the spot can be increased as long as the power of the laser is high enough to produce sufficient fluence for a given spot to ablate a selected material. Since the spot size is typically less than a width of the channel, multiple passes can be made to produce the desired channel.

A scan rate and pulse repetition rate of a laser determines the overlap between the pulses. To maximize the throughput and maintain the quality of a cut, overlap between the pulses is typically adjusted from 50% to 100%, depending on the fluence applied. Typical pulse repetition rates on the order of tens of kHz up to hundreds of kHz can be used with enough energy in each pulse to ablate the material. Higher repetition rates enable the laser beam to be scanned across a surface at a faster rate.

A scan pattern can be designed that allows a continuous channel 106 pattern to be formed in the host layer 102. The scan pattern can be a raster scan pattern consisting of substantially parallel runs of the laser beam across a surface of the channel until the channel reaches the desired dimensions. Alternatively a window scan, also referred to as a horse track scan, can be used.

Surface ablation may leave residue or surface structure that does not meet desired surface and edge smoothness tolerances. A polish etching process for silicon or glass, as previously discussed, or a thermal reflow process for polymers may be used to bring the surface and edges of the channel within the desired tolerances. The channel formed through laser ablation micromachining and/or etching can then have a metallization layer 110 added. A lid portion 120 having a metallization layer 126 formed can be bonded on the base portion after the channel has been created to form a large core hollow metal waveguide 150, as previously discussed and illustrated in FIGS. 1c-1e.

In another embodiment, a laser direct write process can be used to form a channel 106 in a host layer 102, as illustrated in FIG. 1b. In this embodiment, the host layer can be comprised a negative photoresist formed of a material such as SU8 or a positive photoresist formed of a material such as Shipley Ultra-i 123. The host layer can be formed on a substrate layer 104 comprising FR-4 board, polymers such as polycarbonate, laminated SU8 on silicon, and so forth. The host layer comprised of the photoresist can be applied to the substrate layer using an inkjet, doctor blade, spin coat, screen print, or laminate process, as can be appreciated.

A laser having a fluence of approximately 100 millijoules per centimeter squared with an output frequency in the ultraviolet wavelength range can be used to expose the photoresist. In one embodiment, a single laser pulse of approximately eight nanoseconds from an injection-seeded, frequency tripled Q-switched Nd:YAG laser having a wavelength of 355 nanometers can be used to properly expose the photoresist as the laser is scanned across the surface. Other types of lasers such as a continuous wavelength light source, solid state lasers, or excimer lasers with varying pulse width and a wavelength shorter than 365 nm (the i-line) can be used for photo induced changes in the photoresist precursor that results in a cationic photo-polymerization of the epoxy.

SU8 provides a good structural material as the host layer in which to form one or more channels 106 using the laser direct write process. SU8 is a negative photoresist. Thus, a mask can be formed to cover the channels area 106 when using a broad exposure with an ultraviolet light source to define a waveguide channel. For a direct write patterning process, the laser can be scanned over the material outside of the channels in a prescribed pattern using, for example, a computer to control scanning of the laser to allow the area outside of the channels to be exposed and polymerized. This process can be used to fabricate a template used in an embossing process.

The beam size in the laser direct write process can be optimized to produce the target structure. The laser beam should have a Rayleigh length sufficient to form relatively flat side walls within the channel 106. For example, in one embodiment the channel can have a width 107 and a depth 105 of approximately 150 micrometers. A laser beam having a 50 micrometer spot size at a wavelength of 355 nanometers can have a Rayleigh range of approximately 20 millimeters, which enables a sufficiently flat side wall for a 150 micrometer deep waveguide channel. The laser beam can be scanned over areas outside the channel region to polymerize the material and allow for its removal. Alternatively, just the areas around and between the channels can be exposed and the channel area is removed to a depth of approximately 150 micrometers.

The developing and curing process of a material such as SU8 is well known. The process involves cleaning and rinsing the substrate 104 in organic solvents to provide good uniform coating and adhesion. The substrate can then be coated with the SU8 material using any casting process such as spin coating, doctor blading, screen printing, ink jetting, and the like to form the host layer 102. A pre-bake can then be used to remove substantially all of the solvent in the SU8. The material outside the channels 106 can then be exposed with laser light, as discussed above. A post exposure bake can be used for cationic photopolymerization of the epoxy at a higher temperature than the glass transition temperature and the structure can be developed in an ethyl-lactate solution, followed by a rinse and dry process. Flood exposure under homogenous ultraviolet light and an additional baking step is applied when necessary to prevent the flowing of the SU8 structure.

In another embodiment, a photostructuring process can be used to form a channel 106 in a host layer 102. Photostructuring involves the exposure of photosensitive glass with ultraviolet light with an energy density above a threshold value. For example, a photosensitive glass called FOTURAN® having a thickness of approximately 1 millimeter can be exposed with a laser in the ultraviolet wavelength with an energy density of approximately 20 joules per centimeter squared. The laser can scan over a desired area to expose a mask pattern to form the channel in the host layer. The laser in this example can have a wavelength in the range of 290 to 330 nanometers.

Alternatively, a mask made from a material such as chromium or quartz can be used to mask areas other than the channels 106. A mercury lamp can then be used to expose the channel areas. The photosensitive glass can then be baked at a temperature of approximately 500-600 C for a period of around two hours. The material can then be etched using an etchant such as hydrofluoric acid at a concentration of about ten percent. The etch rate of the exposed area is approximately ten micrometers per minute. The etch rate of the non-exposed areas is about 1/20^{th} the etch rate of the exposed areas. This allows the exposed column areas having a width and depth of approximately 150 micrometers to be formed in about fifteen to twenty minutes. The channel formed through photo structuring can then have a metallization layer 110 added. A lid portion 120 having a metallization layer 126 can be bonded on the base portion after the channel has been created to form a large core hollow metal waveguide 150, as illustrated in FIGS. 1c-1e.

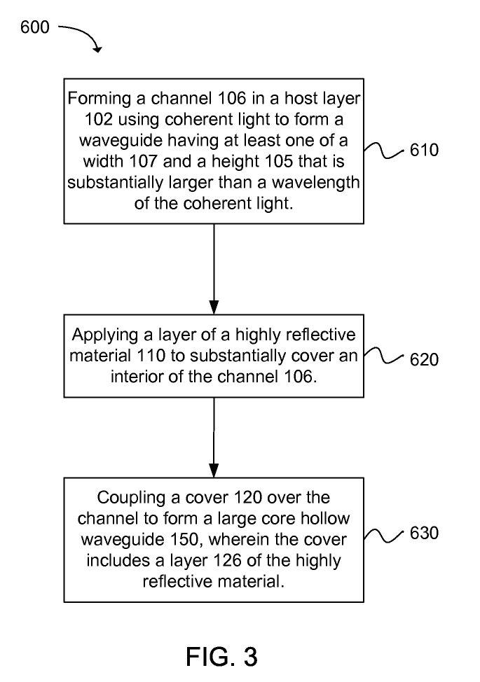

In another embodiment, a method 600 for making a photonic guiding system for directing coherent light is disclosed, as depicted in the flow chart in FIG. 3. The method includes the operation of forming 610 a channel 106 in a host layer 102 using coherent light to form a waveguide. The coherent light can be used to form the channel using the laser ablation method, the laser direct write method, and the photo-structuring method. The waveguide is configured to interconnect electronic circuitry on at least one circuit board. The channel 106 has at least one of a width 107 and a height 105 that is substantially larger than a wavelength of the coherent light. The method further includes the operation of applying 620 a layer of a highly reflective material 110 to substantially cover an interior of the channel 106. An additional operation involves coupling 630 a cover 120 over the channel to form a large core hollow waveguide 150. The cover 120 includes a layer 126 of the highly reflective material.

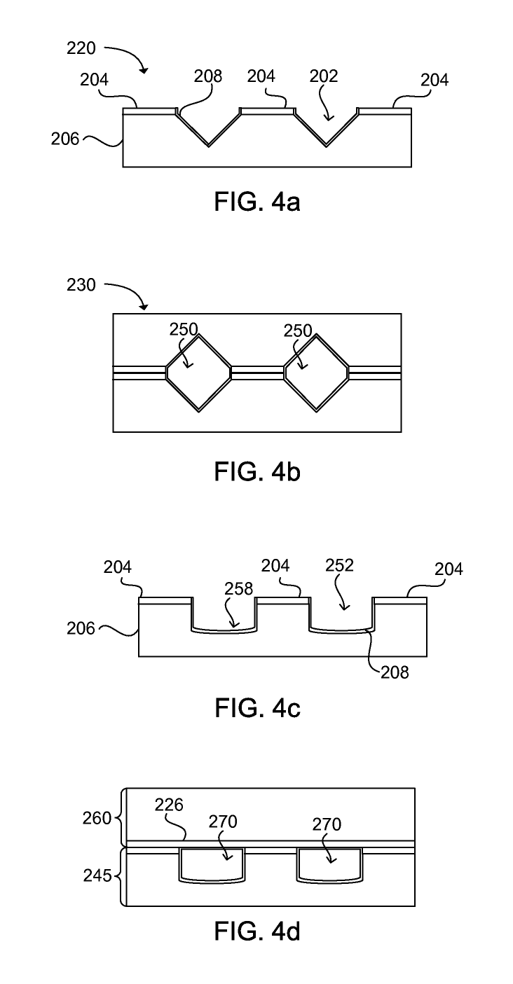

In another embodiment, etching can be used to form a channel in a host layer. For example, an embodiment illustrated in FIG. 4a shows a silicon wafer in the 100 crystallographic orientation that can be etched to produce a triangular shaped waveguide 202. TMAH or potassium hydroxide (KOH) can be used to provide anisotropic etching at a rate of approximately 0.5 micrometers per minute at elevated temperatures for the silicon wafers. The etching process produces the triangle shaped waveguide with the triangle walls at an angle of approximately 54 degrees relative to a normal orthogonal to the surface of the silicon.

A hard mask 204 formed of a material such as silicon dioxide or silicon nitride and patterned with laser machining or a dry etch process using a soft mask can be used to define the waveguide 202 structures in the silicon host layer 206. A metallization layer 208 can be formed over the triangle shaped waveguide channels. One waveguide section 220 having at least one triangle shaped waveguide channel 202 can be inverted and placed on another waveguide section 220 having at least one triangle shaped waveguide channel to form a single waveguide section 230 having at least one substantially square hollow metal waveguides 250, as illustrated in FIG. 4b. The sections having triangle shaped waveguides can be joined using wafer level bonding, as previously discussed.

Another embodiment illustrated in FIG. 4c shows a silicon wafer in the 110 crystallographic orientation that can be etched to produce a substantially square shaped waveguide 252 having a sloped bottom area 258. TMAH or potassium hydroxide (KOH) can be used to provide anisotropic etching at a rate of approximately 0.5 micrometers per minute at elevated temperatures for the silicon wafers.

A hard mask 204 formed of a material such as silicon dioxide or silicon nitride can be used to define the waveguide 252 structures in the silicon host layer 206. The channel formed through etching can then have a metallization layer 208 added. A lid portion 260 having a metallization layer 226 can be bonded on the base portion 245 after the channel has been created to form at least one large core hollow metal waveguide 270, as illustrated in FIG. 4d.

The substantially square large core hollow metal waveguides 250 formed by etching in the 100 crystallographic orientation and the large core hollow metal waveguides 270 having a sloped bottom area formed by etching in the 110 crystallographic orientation can be formed with sufficiently smooth sides that they can carry an optical signal with minimal loss. The slightly non-square shapes of the waveguides formed using etching are not sufficient to substantially adversely affect the propagation of the optical signal through the hollow metal waveguides.

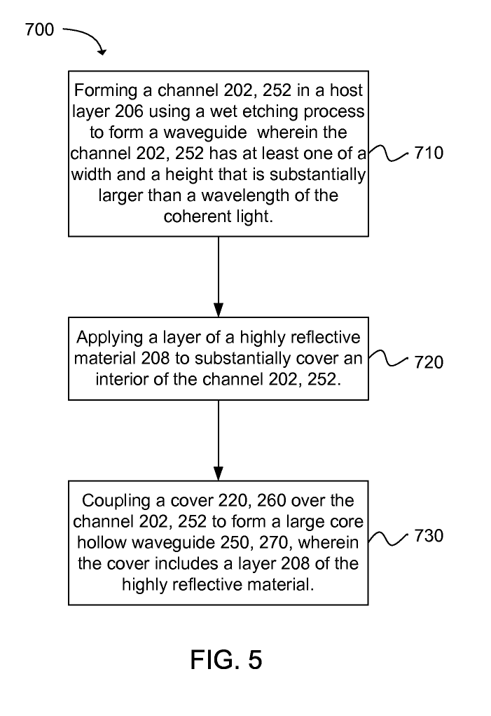

In another embodiment, a method 700 for making a photonic guiding system for directing coherent light is disclosed, as depicted in the flow chart of FIG. 5. The method includes the operation of forming 710 a channel 202, 252 in a host layer 206 using an etching process to form a waveguide. The waveguide can be configured to interconnect electronic circuitry on at least one circuit board. The channel 202, 252 has at least one of a width and a height that is substantially larger than a wavelength of the coherent light. The method further includes applying 720 a layer of a highly reflective material 208 to substantially cover an interior of the channel 202, 252. An additional operation involves coupling 730 a cover 220, 260 over the channel 202, 252 to form a large core hollow waveguide 250, 270, wherein the cover includes a layer 208 of the highly reflective material.

The operation of forming the channel 202 in the host layer 206 using the etching process further comprises the operation of etching a first silicon host layer 206 in the 100 crystallographic orientation to form a triangle shaped waveguide channel 202 in a first waveguide section 220. A second silicon host layer is also etched in the 100 crystallographic orientation to form a triangle shaped waveguide channel 202 in a second waveguide section 220. The first waveguide section and the second waveguide section are bonded to form a single waveguide section 230 having at least one substantially square hollow metal waveguide 250.

The large core hollow metal waveguides with internal reflective surfaces can serve as a relatively inexpensive, low loss means for interconnecting components on one or more printed circuit boards. The low loss of the guiding device enables the device to be more commonly used in commodity products, such as interconnecting electronic circuitry optically.

Electronic circuitry can include electrical circuitry, wherein electrical signals transmitted from the circuitry are converted to optical signals and vice versa. Electronic circuitry can also include optical circuitry that can communicate directly using optical signals without a need for conversion. The electronic circuitry may be contained on a single circuit board. Alternatively, the electronic circuitry may be located on two or more separate circuit boards and the waveguide can be used to interconnect the boards. It is also relatively easy to tap and direct the optical signals from these waveguides through the use of a tilted semi-reflecting surface. This is rather difficult for conventional waveguides to achieve due to the larger numerical aperture of conventional waveguides.

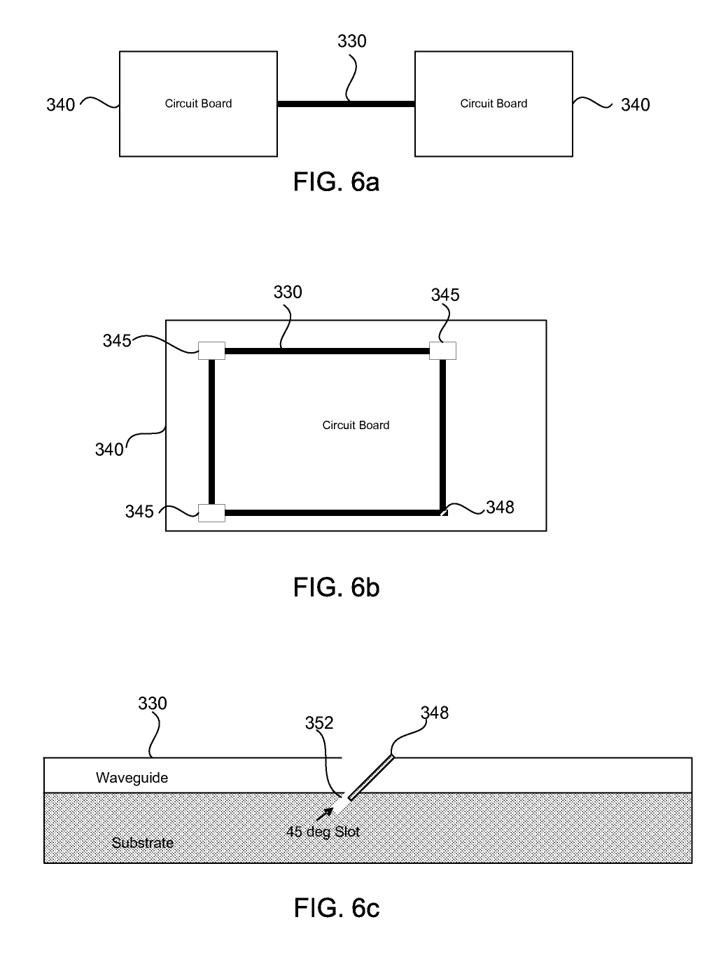

For example, FIG. 6a shows a large core hollow waveguide 330 with internal reflective surfaces. The hollow waveguide is used to couple two circuit boards 340. The larger waveguide can reduce the cost of interconnecting the waveguide between the boards, as previously discussed. The reflective surfaces within the waveguide can reduce loss, enabling a low power signal of coherent light to be transmitted through the waveguide to the adjoining circuit board. An coherent light device, such as a single mode laser, a multi-mode laser, or a light emitting device located on one or both of the circuit boards, can be used to transmit the coherent light. A collimating lens can be included on one or both of the circuit boards and optically coupled to the waveguide. The collimating lens can reduce the losses of higher modes of light caused by multiple reflections. The hollow waveguide 330 interconnect may be configured to be coupled between the boards in a manufacturing process. Alternatively, the hollow waveguide may be formed as a connector and/or cable that can be connected to the boards after they are manufactured.

The hollow waveguide 330 with internal reflective surfaces may also be used to interconnect electronic components 345 on a single circuit board 340, as shown in FIG. 6b. An electronic component may be used to redirect the light from one waveguide to another. Alternatively, ninety degree turns are relatively easy to achieve by inserting a redirecting device 348 at an angle of approximately 45 degrees from the beam. A slot 352 may be cut in the hollow waveguide 330 as shown in FIG. 6c, using, for example, a dicing saw with an angled blade. A beveled blade or angled blade may be used depending on the required routing of optical signals with the insertion of micro-optical structures or optical micro-electro-mechanical systems. Alternatively, laser micromachining or micro-milling processes for silicon or glass or similar patterning techniques described for waveguide channel formation in polymeric layers can be used for splitter slot formation. The slot may continue into the substrate to provide added structural support to attach the redirecting device. The redirecting device may be coupled to the waveguide using adhesive. The redirecting device may be a mirror, as can be appreciated. Alternatively, an optical beam splitter, an aperture, a semi transparent mirror, a diffractive grating, or a scatterer or similar type of optical device may also be used in place of the mirror if only a portion of the light is desired to be redirected.

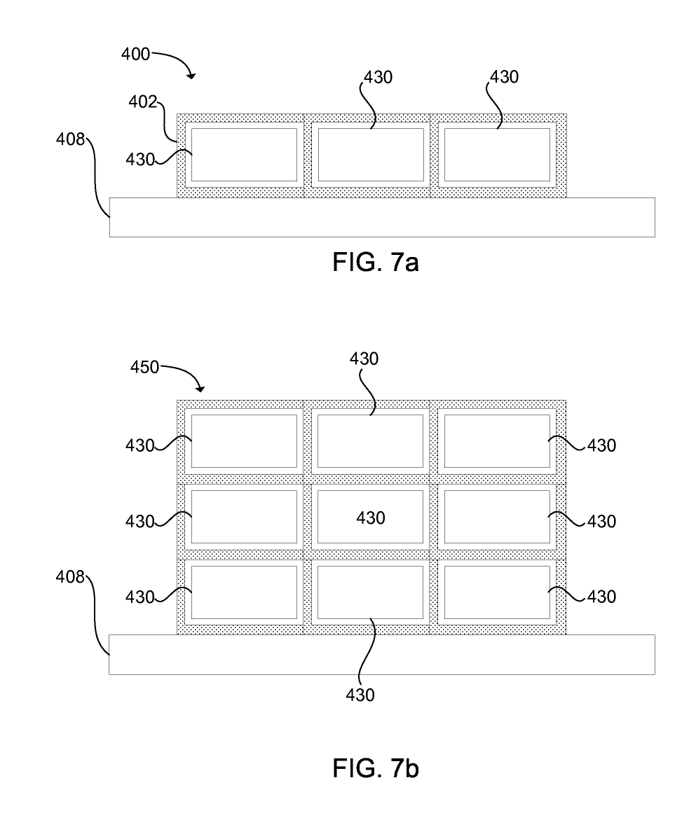

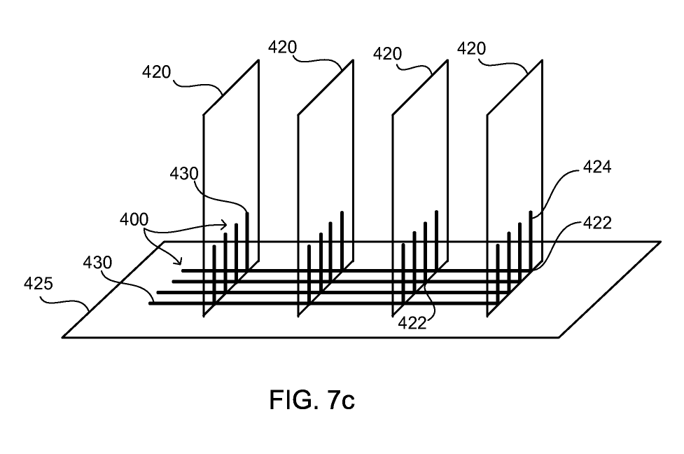

Each of the large core hollow metal waveguides formed using the processes that have been discussed can be formed in two dimensional arrays and three dimensional arrays to enable multiple signals to be directed. For example, FIG. 7a illustrates a two dimensional array 400 of hollow waveguides 430. Each waveguide can be surrounded by a reflective material 402, as previously discussed. The array of waveguides can be constructed on a substrate or host material 408 repeating the methods disclosed previously or the methods combined with conventional lithography, embossing, or injection molding processes. Continuous stacks or laminates of channel patterned layers defined with such methods as embossing, injection molding, conventional lithography, or the methods described herein can produce waveguide arrays at low cost and integrate optical layers with electrical layers on or within FR4 board. FIG. 7b illustrates a three dimensional array 450 of hollow waveguides 430 constructed on a substrate or host material 408.

FIG. 7c illustrates an array 400 of hollow waveguides 430 coupled to a circuit board. The array may be a two dimensional array constructed in a single layer of the circuit board. Alternatively, the array may be a three dimensional array constructed on two or more layers of the circuit board. The circuit board can act as the substrate 408 to which each hollow waveguide in the array can be attached. In one embodiment, the circuit board can be configured as an optical backplane 425. Coherent light can be directed into each of the waveguides. A coupling device 422, such as an optical splitter, can be configured to direct at least a portion of the guided multi-mode coherent light beam out of the waveguide at a selected location. The beam splitter(s) can be inserted by forming a slot in the hollow waveguide, as previously discussed and illustrated in FIG. 6c. The optically coupled waveguide may be orthogonal to the backplane, although substantially any angle may be used.

Redirecting the multi-mode coherent light out of the plane of the circuit board can enable a plurality of circuit cards, such as daughter boards 420, to be optically coupled to a backplane 425. High data rate information that is encoded on the coherent light signal can be redirected or distributed from the backplane to the plurality of daughter boards.

Large core hollow waveguides with a reflective interior coating enable transmission of high data rate information to a plurality of different boards. The low loss of the hollow waveguides enables a single optical signal to be routed into multiple other waveguides. A coherent light beam that is guided through each waveguide can carry data at a rate of tens of gigabits per second or higher. The light beam essentially propagates at the speed of light since the index of the mode is nearly unity, resulting in a substantially minimal propagation delay. The optical interconnects enabled by the hollow waveguides provide an inexpensive means for substantially increasing throughput between chips and circuit boards.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for making a photonic guiding system for directing coherent light, comprising:
forming a channel in a host layer using at least one process selected from the group consisting of sawing, molding, and embossing the channel to form a waveguide configured to interconnect electronic circuitry on at least one circuit board, wherein the channel has at least one of a width and a height that is substantially larger than a wavelength of the coherent light;
applying a layer of a highly reflective material to substantially cover an interior of the channel;
coupling a cover over the channel to form a large core hollow waveguide, wherein the cover includes a layer of the highly reflective material.

2. A method as in claim 1, further comprising forming the channel in the host layer using a dicing saw.

3. A method as in claim 1, further comprising forming the channel in the host layer using a dicing saw having a blade that is substantially the same thickness as the width of the channel to allow the channel to be formed in a single pass.

4. A method as in claim 1, further comprising forming the channel in the host layer using a dicing saw having a blade with a thickness that is less than the width of the channel to allow the channel to be formed in more than one pass of the blade.

5. A method as in claim 1, further comprising forming the channel in the host layer using a dicing saw having at least two blades used to cut multiple waveguide channels in one pass.

6. A method as in claim 1, further comprising forming the channel in the host layer using a dicing saw having multiple spindles with a variable distance between the spindles, with each spindle having at least one blade to cut multiple waveguide channels in one pass.

7. A method as in claim 1, further comprising polishing a surface of the channel with a polishing etch to smooth the surface such that the surface has an average smoothness within a desired tolerance.

8. A method as in claim 1, further comprising laminating a plurality of layers together to form the host layer in which the channel will be formed.

9. A method as in claim 1, further comprising laminating a plurality of large core hollow metal waveguides to form a three dimensional structure having a three dimensional array of large core hollow metal waveguides.

10. A method as in claim 1, further comprising forming the channel in the host layer, wherein the host layer is comprised of a polymer and the channel is formed in the polymer using one of an embossing process and a molding process.

11. A method for making a photonic guiding system for directing coherent light, comprising:
forming a channel in a host layer using coherent light to form a waveguide configured to interconnect electronic circuitry on at least one circuit board, wherein the channel has at least one of a width and a height that is substantially larger than a wavelength of the coherent light;
applying a layer of a highly reflective material to substantially cover an interior of the channel;
coupling a cover over the channel to form a large core hollow waveguide, wherein the cover includes a layer of the highly reflective material.

12. A method as in claim 11, wherein forming the channel in the host layer using coherent light further comprises using a laser to ablate material in the host layer to form the channel.

13. A method as in claim 12, further comprising using the laser to ablate material with the laser having a spot size within a range of 10 micrometers to 100 micrometers.

14. A method as in claim 11, wherein forming the channel in the host layer using coherent light further comprises using a laser to expose a selected area of the host layer to enable the channel to be formed by removing one of the exposed and unexposed areas of the host layer to form the channel.

15. A method as in claim 11, wherein forming the channel in the host layer using coherent light further comprises using a laser to expose a selected channel area in the host layer, wherein the host layer is a photosensitive glass and etching the exposed channel area to form the channel.

16. A method as in claim 11, wherein forming the channel in the host laser using coherent light further comprises directing a laser using a scan pattern designed to provide a continuous channel pattern to be formed in the host layer.

17. A method for making a photonic guiding system for directing coherent light, comprising:
forming a channel in a host layer using an etching process to form a waveguide configured to interconnect electronic circuitry on at least one circuit board, wherein the channel has at least one of a width and a height that is substantially larger than a wavelength of the coherent light;
applying a layer of a highly reflective material to substantially cover an interior of the channel;
coupling a cover over the channel to form a large core hollow waveguide, wherein the cover includes a layer of the highly reflective material.

18. A method as in claim 17, wherein forming the channel in the host layer using the etching process further comprises:
etching a first silicon host layer in the crystallographic orientation to form a triangle shaped waveguide channel in a first waveguide section;
etching a second silicon host layer in the crystallographic orientation to form a triangle shaped waveguide channel in a second waveguide section; and
bonding the first waveguide section and the second waveguide section to form a single waveguide section having at least one substantially square hollow metal waveguide.

19. A method as in claim 17, wherein forming the channel in the host layer using the etching process further comprises:
etching a silicon host layer in the crystallographic orientation to form a substantially square shaped waveguide having a sloped bottom area;
coupling a cover over the channel to form a large core hollow waveguide, wherein the cover includes a layer of the highly reflective material.

20. A method as in claim 17, wherein the layer of the highly reflective material is comprised of a titanium buffer layer used as an adhesion improving layer on a host material, an aluminum nitride passivation layer, and a silver reflective metal layer.
